(19) United States
(12) Patent Application Publication
(10) Pub. No.: US 2012/0281037 A1
(43) Pub. Date: Nov. 8, 2012

(54) PRINTING APPARATUS AND CONTROL METHOD THEREOF

(75) Inventor: Akihiro Toya, Matsumoto-shi (JP)

(73) Assignee: SEIKO EPSON CORPORATION, Tokyo (JP)

(21) Appl. No.: 13/463,357

(22) Filed: May 3, 2012

(30) Foreign Application Priority Data
May 6, 2011 (JP) 2011-103570

(51) Int. Cl. B41J 29/38

(52) U.S. Cl. 347/16

(57) ABSTRACT

A printing apparatus includes: a printing unit that applies a liquid to a printing medium to perform printing; a support member that supports the printing medium; a drying device that dries the liquid applied onto the printing medium in a drying space; and a control device that is connected to the drying device, wherein the drying device includes an air supply port for supplying a drying gas to the drying space, and an air supply position changing mechanism that changes a position of the air supply port for the drying space with respect to the printing medium.

### BACKGROUND

The entire disclosure of Japanese Patent Application No: 2011-103570, filed May 6, 2011, is expressly incorporated by reference herein in its entirety.

1. Technical Field

The present invention relates to a printing apparatus and a control method thereof.

2. Related Art

Recently, as an image printing apparatus capable of simply printing an image at a high speed and with a low cost as compared with a printing method in which plate making is necessary such as gravure printing and flexography printing, an image printing apparatus based on an ink jet printing method, that is, an ink jet printing apparatus has come into wide use. Since the ink jet printing apparatus employs a method of ejecting an ink from a printing head to land the ink on a printing medium to print an image on the printing medium, it is possible to print an image even on a printing medium with poor ink absorptiveness such as a resin film or metal on which it is difficult to print an image in the image recording method of the related art, other than paper and fabric as the printing medium.

Generally, such a printing medium is transported on an upper portion of a support plate called a platen, and an ink is ejected from a printing head above the platen. The ink (application material) applied on the printing medium is dried by a drying device in a post-process and is fixed to the printing medium. At the time of drying the application material, a drying blur occurs and there may be a bad influence on application characteristics.

In JP-A-2009-000620, an apparatus is disclosed in which a plurality of drying zones are sequentially disposed along a transport direction.

However, in the related art described above, there are the following problems.

Even when the plurality of drying zones are sequentially disposed along the transport direction, since the drying is performed with wind in a single direction in the drying zone on the upstream side, the drying blur may occur. In this case, it is difficult to solve the drying blur once it has occurred in the drying zone on the downstream side. Since the plurality of drying zones are provided, a problem that a size of the apparatus becomes large occurs.

### SUMMARY

An advantage of some aspects of the invention is to provide a printing apparatus and a control method thereof, capable of effectively preventing a drying blur from occurring without increasing the size of the apparatus.

According to an aspect of the invention, there is provided a printing apparatus including: a printing unit that applies a liquid to a printing medium to perform printing; a support member that supports the printing medium; a drying device that dries the liquid applied onto the printing medium in a drying space; and a control device that is connected to the drying device, wherein the drying device includes an air supply port for supplying a drying gas to the drying space, and an air supply position changing mechanism that changes a position of the air supply port for the drying space with respect to the printing medium.

With such a configuration, the position of the air supply port for the drying space is changed with respect to the printing medium, and thus the drying air is prevented from being stagnant in the drying space. Accordingly, it is possible to dry the liquid in uniform drying conditions, and thus it is possible to prevent drying blur from occurring.

In the printing apparatus, the air supply port may be configured by a plurality of first supply holes which are open to the drying space and a plurality of second supply holes disposed at positions overlapping the first supply holes in a plan view, and the air supply position changing mechanism may move a second plane on which the plurality of second supply holes are disposed in parallel with respect to a first plane on which the plurality of first supply holes are disposed, to change the position of the air supply port.

As descried above, the air supply port is configured by the overlapping part of the first supply holes and the second supply holes in the plan view, and moves the second plane on which the plurality of second supply holes are disposed in parallel with respect to the first plane on which the plurality of first supply holes are disposed so that the position of the air supply port for the drying space may be changed. Accordingly, it is possible to directly blow the drying air to the printing medium without allowing the drying air to stagnate.

In the printing apparatus, the air supply position changing mechanism may move the second plane may move in parallel with respect to the first plane such that an opening area of the air supply port is constant.

With such a configuration, it is possible to keep the supply amount and the supply rate of the drying air supplied to the drying space through the air supply port constant, it is possible to secure uniform drying conditions, and thus it is possible to secure the same drying quality for each printing medium.

According to another aspect of the invention, there is provided a control method of a printing apparatus including a printing unit that applies a liquid to a printing medium to perform printing, a support member that supports the printing medium, a drying device that dries the liquid applied onto the printing medium in a drying space, and a control device that is connected to the drying device, wherein the drying device includes an air supply port for supplying a drying gas to the drying space, and an air supply position changing mechanism that changes a position of the air supply port for the drying space with respect to the printing medium, the method including: printing an image by applying the liquid to the printing medium; transporting the liquid applied onto the printing medium to the drying space; and drying the liquid on the printing medium disposed in the drying space, wherein in the drying, the position of the air supply port for supplying the drying gas to the drying space is changed with respect to the printing medium.

With such a configuration, the position of the air supply port for the drying space is changed with respect to the printing medium, and thus the drying air is prevented from stagnating in the drying space. Accordingly, it is possible to dry the liquid in uniform drying conditions, and thus it is possible to prevent drying blur from occurring.

In the control method of the printing apparatus, in the drying, the position of the air supply port may be changed every time at the same cycle within a predetermined drying time.

With such a configuration, it is possible to dry the liquid in uniform drying conditions, and thus it is possible to prevent drying blur from occurring.

In the control method of the printing apparatus, the drying to the printing medium positioned at the front of the transport direction and the printing positioned relatively at the rear of the transport direction may be simultaneously performed.

With such a configuration, the drying to the printing medium positioned at the front of the transport direction and the printing on the printing medium positioned relatively at the rear of the transport direction may be simultaneously performed, and thus it is possible to efficiently perform the printing process on the printing medium.

In the control method of the printing apparatus, the drying time may be the same time as the printing time in the printing.

With such a configuration, it is possible to easily control the drying device by the control device.

### BRIEF DESCRIPTION OF THE DRAWINGS

The invention will be described with reference to the accompanying drawings, wherein like numbers reference like elements.

FIG. 1 is a diagram illustrating a schematic configuration of a printer of an embodiment.

FIG. 2 is a plan view illustrating a printing area where the printer performs printing.

FIG. 3 is a functional block diagram of the printer.

FIG. 4 is a diagram illustrating a schematic configuration of a drying device.

FIG. 5A and FIG. 5B are diagrams illustrating a schematic configuration of an air supply position changing mechanism.

FIG. 6 is a diagram illustrating a flow state of hot wind supplied to a continuous sheet.

FIG. 7 is a diagram illustrating a timing chart in a printing process and a drying process of the printer.

FIG. 8 is a schematic diagram illustrating a modification example of the air supply position changing mechanism.

FIG. 9 is a diagram illustrating a modification example of disposition of nozzle holes and through-holes.

### DESCRIPTION OF EXEMPLARY EMBODIMENTS

Hereinafter, an embodiment of the printing device of the invention will be described.

The following embodiment represents an embodiment of the invention, does not limit the invention, and may be arbitrarily modified within the technical concept of the invention. In the following drawings, to easily understand configurations, the scale and the number of the structures are different from those of the actual structure.

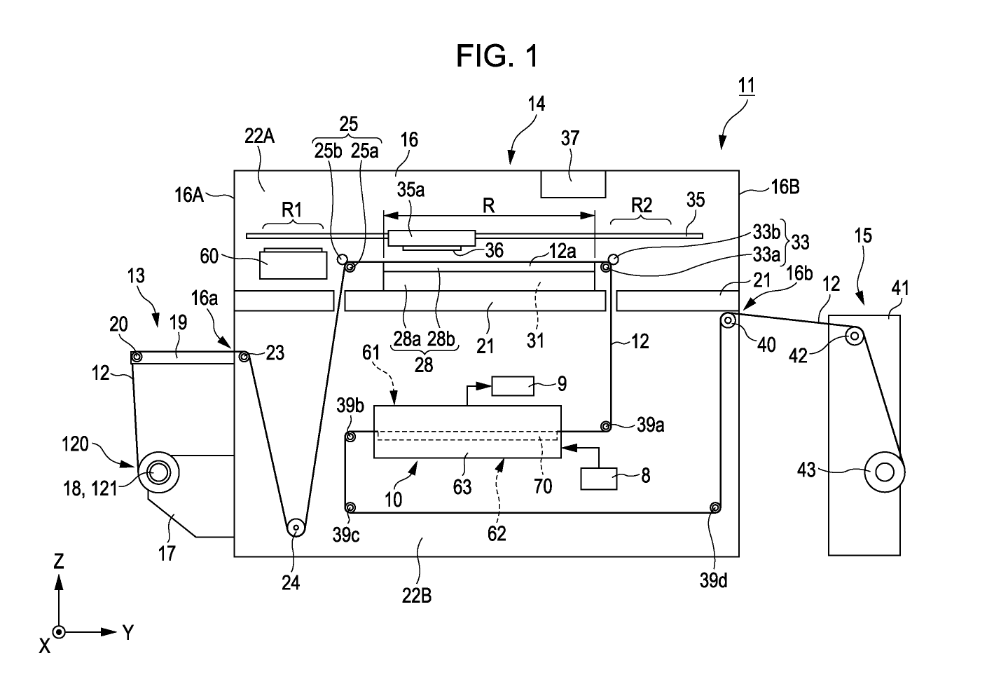

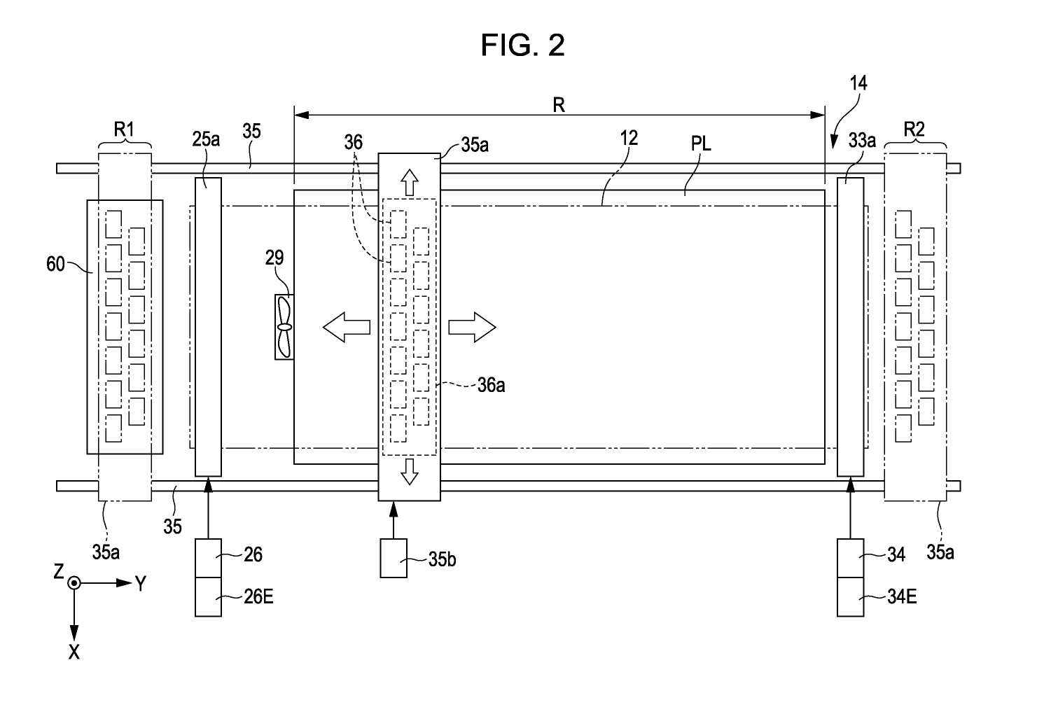

FIG. 1 is a diagram illustrating a schematic configuration of a printer according to the embodiment. FIG. 2 is a plan view illustrating a printing area where the printer performs printing.

The printer (printing apparatus) 11 employs an ink jet method of ejecting a liquid as an application material onto a continuous sheet (printing medium) 12 from a plurality of printing heads (printing unit) 36, as a printing method, performs a printing process while sequentially feeding the longitudinal continuous sheet 12 wound in a roll shape, and after the printing the continuous sheet 12 is wound in a roll shape again.

In the embodiment, an XYZ orthogonal coordinate system is set such that a width direction of the continuous sheet 12 in a horizontal plane is an X direction, a transport direction of the continuous sheet 12 perpendicular to the X direction is a Y direction, and a vertical direction is a Z direction.

The printer 11 includes a body unit 14 that performs a printing process, an feeding unit 13 that supplies the continuous sheet 12 to the body unit 14, a winding unit 15 that winds the continuous sheet 12 discharged from the body unit 14, and a drying device 10 that performs a drying process on the continuous sheet 12 subjected to the printing process.

The body unit 14 is provided with a body case 16, the feeding unit 13 is provided on the transport direction upstream side (−Y side) of the body case 16, and the winding unit 15 is provided on the transport direction downstream side (+Y side) of the body case 16. The feeding unit 13 is connected to a medium feeding unit 16a provided on a side wall 16A of the transport direction upstream side (−Y side) of the body case 16, and the winding unit 15 is connected to a medium discharge unit 16b provided on a side wall 16B of the transport direction downstream side (+Y side).

The feeding unit 13 includes a support plate (support unit) 17 that is provided at the lower portion of the side wall 16A of the body case 16, a winding shaft 18 that is provided on the support plate 17, a feeding base 19 that is connected to the medium feeding unit 16a of the body case 16, and a relay roller 20 that is provided at the leading end of the feeding base 19. A roll body 120 is rotatably supported by the winding shaft 18. The roll body 120 is supported such that the longitudinal continuous sheet 12 is wound around the shaft of a sheet tube (shaft unit) 121 in a roll shape and is wound in the cylindrical sheet tube 121, with the shaft 18 inserted.

The continuous sheet 12 continuously fed from the winding shaft 18 (roll body 120) is wound on the relay roller 20, is diverted to the upper face of the feeding base 19, and is transported to the medium feeding unit 16a along the upper face of the feeding base 19.

The winding unit 15 includes a winding frame 41, and a relay roller 42 and a winding driving shaft 43 provided in the winding frame 41. The continuous sheet 12 discharged from the medium discharge unit 16b is wound on the relay roller 42, is guided to the winding driving shaft 43, and is wound in a roll shape by rotation of the winding driving shaft 43.

In the body case 16 of the body unit 14, a plate-shaped base 21 is horizontally provided, and the inside of the body case is partitioned into two spaces by the base 21. The upper space of the base 21 is a printing chamber 22A in which the printing process is performed on the continuous sheet 12, and the lower space is a drying chamber 22B in which the drying process is performed on the continuous sheet 12.

In the printing chamber 22A, a platen (support member) 28 that is fixed on the base 21, a printing head (printing unit) 36 that is provided above the platen 28, a carriage 35a that supports the printing head 36, two guide shafts 35 (see FIG. 2) that support the carriage 35a, and a valve unit 37. Two guide shafts 35 are disposed parallel to each other along the transport direction (Y direction), and are configured such that the carriage 35a is reciprocally movable in the transport direction.

As shown in FIG. 1 and FIG. 2, the platen 28 includes a box-shaped support base 28a, an upper face of which is opened, and a placement plate 28b that is provided in the opening of the support base 28a. The support base 28a is fixed on the base 21, the inside surrounded by the support base 28a and the placement plate 28b is a negative pressure chamber 31. The continuous sheet 12 is placed on the support face (mediums support face) PL (FIG. 2) of the placement plate 28b.

A suction fan (suction device) 29 is connected to the placement plate 28b. The inside of the negative pressure chamber 31 is sucked by the suction fan 29, suction force acts on the continuous sheet 12 through a plurality of suction holes (not shown) formed in the placement plate 28b, the continuous sheet 12 is adsorbed to the support face PL of the placement plate 28b, and it is possible to perform flattening.

A pressure detecting sensor (not shown) that detects pressure in the negative pressure chamber 31 is connected to the platen 28. The pressure detecting sensor measures air pressure in the negative pressure chamber 31, the driving of the suction fan 29 is adjusted by the detection result, and the adsorption to the continuous sheet 12 is controlled.

The platen 28 is provided with a heater (not shown), the drying of the ink landing on the surface of the continuous sheet 12 adsorbed to the platen 28 is promoted according to the performing of the printing (first drying).

A supply transport system (transport device) including a plurality of transport rollers is provided on the transport direction upstream side (−Y side) of the platen 28. The supply transport system includes a winding shaft 18 that rotatably supports the roll body 120, a first transport roller pair 25 that is provided in the printing chamber 22A in the vicinity of the platen 28, a relay roller 24 that is provided in a space on the lower end side of the body case 16, and a relay roller 23 that is provided in the vicinity of the medium feeding unit 16a.

The supply transport system in the embodiment intermittently transports the continuous sheet 12 on the platen 28 by each predetermined range.

The first transport roller pair 25 is formed of a first driving roller 25a and a first driven roller 25b. As shown in FIG. 2, the first driving roller 25a is connected to a first transport motor 26 and a first encoder 26E.

In the supply transport system, the continuous sheet 12 input from the feeding unit 13 to the inside of the body case 16 through the medium feeding unit 16a is wound from the lower portion to the first driving roller 25a through the relay rollers 23 and 24, and is nipped from the lower portion to the first transport roller pair 25. The continuous sheet 12 is horizontally fed from the first transport roller pair 25 on the support face PL of the platen 28 according to the rotation of the first driving roller 25a driven by the first transport motor 26.

A discharge transport system including a plurality of transport rollers is provided on the transport direction downstream side (+Y side) of the platen 28. The discharge transport system includes a second transport roller pair 33 that is provided on the opposite side to the first transport roller pair 25 with respect to the plate 28, relay rollers 39a to 39d that are provided in the drying chamber 22B on the lower end side of the body case 16, and a sending-out roller 40 that is provided in the vicinity of the medium discharge unit 16b.

The second transport roller pair 33 is formed of a second driving roller 33a and a second driven roller 33b. As shown in FIG. 2, the second driving roller 33a is connected to a second transport motor 34 and a second encoder 34E. Since the second driven roller 33b is disposed on a printing face side (upper face side) of the continuous sheet 12, the second driven roller 33b may be configured to come in contact with only an end edge portion in the width direction (X direction) of the continuous sheet 12 to avoid a defect of the printed image.

In the discharge transport system, the second transport roller pair 33 nipping the continuous sheet 12 feeds the continuous sheet 12 from the upside of the plate 28 according to the rotation of the second driving roller 33a driven by the second transport motor 34. The continuous sheet 12 fed from the second roller pair 33 is transported to the drying device 10 through the relay roller 39a.

In the drying device 10, a supply device 8 that supplies the air (drying gas: hereinafter, referred to as hot wind) heated for drying to the continuous sheet 12 is connected to an air discharge device 9 that discharges the hot wind used in the drying process. The drying device 10 completely dries the ink landing on the surface of the continuous sheet (second drying). The continuous sheet 12 subjected to the drying process by the drying device 10 is transported to the sending-out roller 40 through the relay rollers 39b to 39d, and is fed to the winding unit 15 through the medium discharge unit 16b by the sending-out roller 40.

The plurality of printing heads 36 are mounted on the carriage 35a through a head attachment plate 36a. The head attachment plate 36a is configured to be movable on the carriage 35a in the medium width direction (X direction). A position of the head attachment plate 36a can be controlled by a head position control unit 35b connected to the carriage 35a, the head attachment plate 36a is moved in the medium width direction (X direction), and thus it is possible to integrally perform a line break operation of the plurality of printing heads 36. On the head attachment plate 36a, the printing heads 36 are arranged at regular intervals in the medium width direction such that the printing heads 36 adjacent to each other alternate to become two steps in the medium transport direction (Y direction).

The head position control unit 35b controls the position of the printing head 36 in the medium width direction (X direction), and controls the position of the carriage 35a in the medium transport direction (Y direction: head scanning direction), to dispose the printing heads 36 at desired positions on the continuous sheet 12.

The plurality of printing heads 36 are connected to the valve unit 37 through an ink supply tube (not shown). The valve unit 37 is provided on an inner wall of the body case 16 in the printing chamber 22A, and is connected to an ink tank (ink storage unit) (not shown). The valve unit 37 supplies the ink to the printing head 36 while temporarily storing the ink supplied from the ink tank.

A plurality of ink ejection nozzles are arranged in the medium width direction (X direction) on the lower face (nozzle-formed face) of the printing head 36. The printing head 36 ejects the ink supplied from the valve unit 37, from the ink ejection nozzles to the continuous sheet 12 on the platen 28 to perform printing.

The printing head 36 may have a plurality of ink ejection nozzle rows. In a case of performing color printing of four colors or six colors, when an ink for each color kind is assigned to each ink ejection nozzle row, it is possible to eject inks of a plurality of colors with one printing head 36.

In the printing chamber 22A, an area on the platen 28 is a printing area R where the printing is performed on the continuous sheet 12 by ink ejection from the ink ejection nozzles. The continuous sheet 12 is intermittently transported by the supply transport system and the discharge transport system described above. Specifically, the continuous sheet 12 with a length corresponding to the printing area R is loaded on the platen 28 whenever the printing is performed, and is fed to the discharge transport system after the printing process.

As shown in FIG. 1 and FIG. 2, a guide shaft 35 extending in the printing chamber 22A extends to the outside in the medium transport direction from the printing area R. Accordingly, the carriage 35a is movable to the area on the outside of the printing area R. A first maintenance area R1 is provided on the medium transport direction upstream side (−Y side) of the printing area R, and a second maintenance area R2 is provided on the medium transport direction downstream side (+Y side).

In the first maintenance area R1, a maintenance unit 60 is provided. The maintenance unit 60 includes, for example, a cap member and a wiping member that are provided corresponding to the printing head 36, and a suction device that is connected to the cap member and sucks the inside of the cap member.

In the second maintenance area R2, the maintenance unit or the like is not provided, and the second maintenance area R2 is a work space to which user's hands or arms can be inserted. The carriage 35a is disposed in the second maintenance area R2, the nozzle-formed face of the printing head 36 can be thereby exposed in the work space, and thus it is possible to perform cleaning of the nozzle-formed face or a replacement work of the printing head 36 by the user.

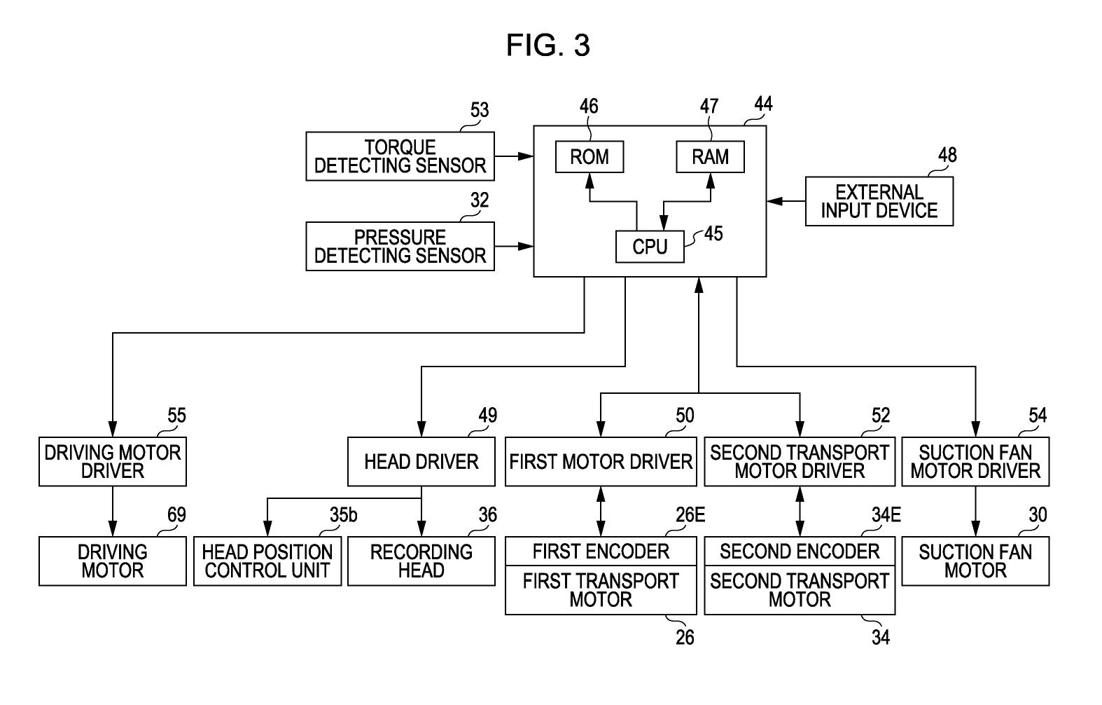

Next, FIG. 3 is a functional block diagram of the printer 11.

As shown in FIG. 3, the printer 11 is provided with a controller (control device) 44 that controls a driving state of the whole apparatus. The controller 44 is provided with a CPU 45 that is a central processing unit, a ROM 46, and a RAM 47. In the ROM 46, programs of a process routine about the printing process and the transport process are stored. The RAM 47 is used as a temporary storage area of an operation result in the CPU 45 or a temporary storage area of printing data or the like input from an external input device 48.

The controller 44 is connected to a head driver 49, a first transport motor driver (first motor control unit) 50, a second motor driver (second motor control unit) 52, a suction fan motor driver 54, a torque detecting sensor 53, a pressure detecting sensor 32, an external input device 48, and a driving motor driver 55.

The head driver 49 is connected to the plurality of printing heads 36 and the head position control unit 35b. The controller 44 reads printing data input from the external input device 48, from the RAM 47, and transmits the read printing data to the head driver 49. The head driver 49 drives the printing head 36 and the head position control unit 35b on the basis of the printing data received from the controller 44, and ejects ink droplets from the ink ejection nozzles of the printing head 36 while controlling the position of the printing head 36 above the continuous paper 12, to form an image on the continuous sheet 12.

The first transport motor driver 50 detects the amount of rotation of the first transport motor 26 on the basis of a count signal output from the first encoder 26E connected to the first transport motor 26, and performs a feedback control of the first transport motor 26. That is, the first transport motor driver 50 drives the first driving roller 25a to rotate by the first transport motor 26 until a transport length reaches a predetermined transport length input from the controller 44, and feeds the continuous sheet 12 from the first transport roller pair 25 on the platen 28.

Meanwhile, the second transport motor driver 52 drives the second transport motor 34 by a torque control on the basis of the control signal input from the controller 44. In the embodiment, the controller 44 is connected to the torque detecting sensor 53 that detects a torque of the second transport motor 34, and the controller 44 performs a feedback control of the torque of the second transport motor 34 through the second transport motor driver 52 on the basis of the detection result of the torque of the second transport motor 34 output from the torque detecting sensor 53. Accordingly, a predetermined tension based on the torque of the second transport motor 34 is applied to the continuous sheet 12 through the second driver roller 33a.

Generally, the motor has substantially a proportional relationship between a torque and an electric current. Accordingly, when a rotation rate of the motor is constant, magnitude of the electric current is determined according to a load of the motor. That is, the magnitude of the electric current necessary to drive the motor is determined according to the load applied to the roller. Accordingly, by detecting the magnitude of the electric current flowing in the motor, it is possible to detect the magnitude of the load applied to the motor.

The suction fan motor driver 54 drive controls the suction fan motor 30 connected to the rotation shaft of the suction fan 29 on the basis of the control signal input from the controller 44. By rotation the suction fan 29 at a predetermined rate by a driving force of the suction fan motor 30, it is possible to depressurize the inside of the negative pressure chamber 31 with a predetermined suction force based on the rotation rate. As a result, the negative pressure in the negative pressure chamber 31 acts on the continuous sheet 12 as an adsorption force to the support face PL of the platen 28 through a plurality of suction holes (not shown) provided on the placement plate 28b.

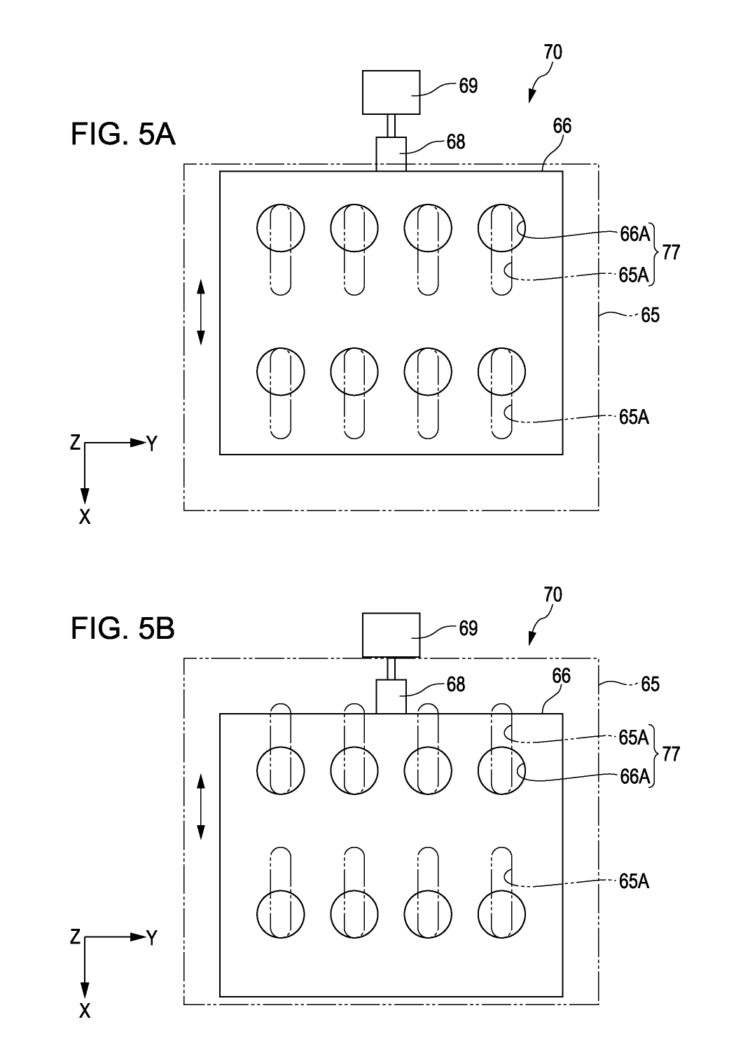

The driving motor driver 55 drive controls the driving motor 69 of the air supply position changing mechanism 70 of the drying device 10 on the basis of the control signal input from the controller 44. By driving a ball screw unit 68 (FIG. 5A and FIG. 5B) by the driving force of the driving motor 69, it is possible to move the position change plate 66 (FIG. 5A and FIG. 5B) forward and backward along the X direction.

Next, a configuration of the drying device will be described.

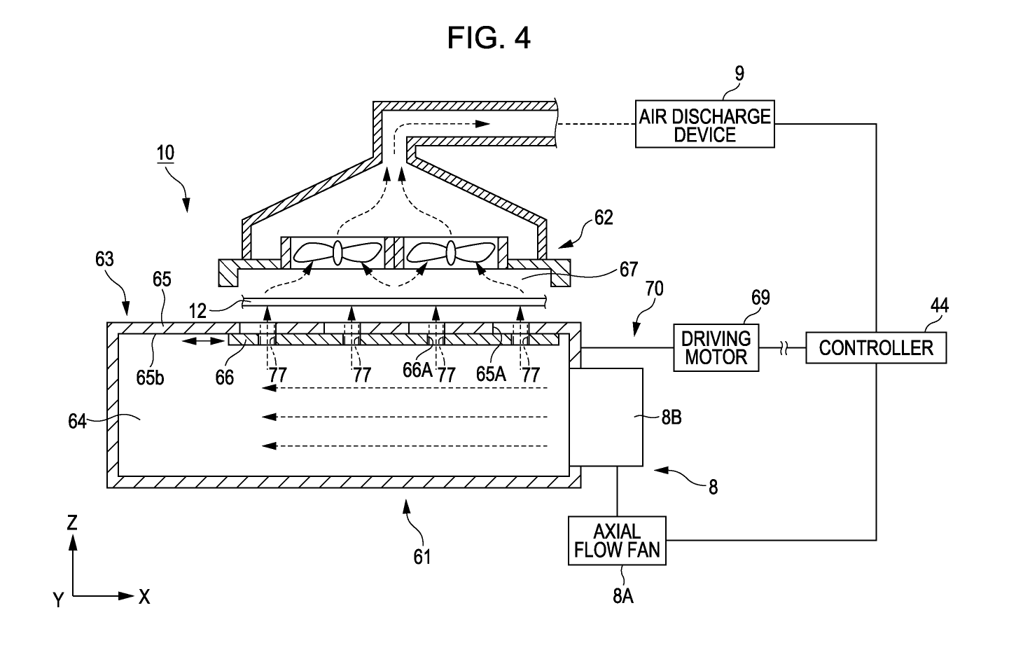

FIG. 4 is a diagram illustrating a schematic configuration of the drying device, and FIG. 5A and FIG. 5B are diagrams illustrating a schematic configuration of the air supply position changing mechanism.

The drying device 10 includes a supply unit 61 connected to the supply device 8, and an air discharge unit 62 connected to the air discharge device 9, and the continuous sheet 12 intermittently transported along the transport direction is disposed in the drying space 67 between the supply unit 61 and the air discharge unit 62 in a state parallel to the XY plane.

The supply unit 61 has a case 63 in which the nozzle plate (first plane) 65 is the top surface, and the hot wind from the supply device 8 is supplied to the supply space 64 formed in the case 63 from the +X direction to the −X direction. The supply device 8 heats the external air sucked by the axial flow fan 8A, by the heater 8B, and supplies the hot wind to the supply space 64.

The nozzle plate 65 is provided with a plurality of nozzle holes (first supply holes) 65A for supplying the hot wind supplied from the supply device 8 into the supply space 64, to the continuous sheet 12 disposed in the drying space 67 in the Z direction. The plurality of nozzle holes 65A are longitudinal holes having a circular shape or an oval shape in the plan view, and are formed such that the longitudinal direction thereof is along the transport direction of the continuous sheet 12. In the embodiment, the longest diameter of the oval is 4 mm, a pitch of the nozzle holes 65A arranged in the X direction is 20 mm, and a pitch of the nozzle holes 65A arranged in the Y direction is 50 mm.

The shape of the nozzle holes 65A in the plan view may be appropriately selected without being limited to the shape described above.

The supply unit 61 is provided with the air supply position changing mechanism 70 for changing the air blow position of the hot wind supplied to the continuous sheet 12. The air supply position changing mechanism 70 includes a position change plate (second plate) 66 disposed parallel to the rear face 65b of the nozzle plate 65, a ball screw unit 68 that is connected to one end of the position change plate 66 and moves the position change plate 66 forward and backward in one direction, and a driving motor 69 (FIG. 5A and FIG. 5B) that drives the ball screw unit 68 (FIG. 5A and FIG. 5B).

In the position change plate 66, a plurality of through-holes (second supply holes) 66A provided corresponding to the nozzle holes 65A of the nozzle plate 65 are formed by a punch press or the like. On the movement path of the position change plate 66, at least a part of each through-hole 66A is overlapped with each corresponding nozzle hole 65A in the plan view. That is, the amount of movement of the position change plate 66 is controlled by the driving motor 69 such that the nozzle hole 65A of the nozzle plate 65 and at least a part of the through hole 66A of the position change plate 66 are overlapped in the plan view. When the position change plate 66 is moved parallel to the X direction along the XY plane with respect to the fixed nozzle plate 65, the positions of the through-holes 66A opposed to the nozzle holes 65A are changed along the longitudinal direction of the nozzle hole 65A, and the air blow position of the hot wind supplied to the continuous sheet 12 through the through-holes 66A and the nozzle holes 65A is changed.

Since the through-holes 66A are set smaller than the opening areas of the nozzle holes 65A, the air supply rate of the hot wind supplied through the air supply port 77 configured by the through-holes 66A and the nozzle holes 65A are higher than the air supply rate of the air supplied from only the nozzle holes 65A. The size (diameter) of the through-hole 66A contributes to the size of the air supply port 77, and thus is set by balance of the temperature and the drying time of the hot wind and the size of the nozzle holes 65A to secure a predetermined velocity and volume of the hot wind supplied from the air supply port 77.

The movement amount of the position change plate 66 in the X direction is the same in the +X direction and the −X direction, and is controlled by the controller 44 such that the position change plate 66 moves forward and backward once along the X direction within a predetermined drying time. Since the positions of the through-holes 66A with respect to the nozzle holes 65A are changed in the X direction according to the movement of the position change plate 66, the position of the air supply port 77 configured by the nozzle holes 65A and the through-holes 66A is also changed in the same direction. That is, the drying process is performed on the continuous sheet 12 while changing the air supply position of the hot wind in the drying space 67 (continuous sheet 12).

As shown in FIG. 5A and FIG. 5B, horizontally moving the position change plate 66 in the X direction by the movement amount in which the opening area of the through holes 66A in the X direction is not changed from the initial state (the whole lengths of the through-holes 66A in the diameter direction are opposed to the nozzle holes 65A), the hot wind is supplied to the continuous sheet 12 at a constant air supply rate and air supply amount from the air supply port 77. Accordingly, it is possible to complete the drying process on the continuous sheet 12 without causing the drying blur.

The position change plate 66 may be moved such that the opening area of the through-holes 66A is smaller than that of the initial state. As described above, when the areas of the whole lengths along the X direction in the through-holes 66A of the position change plate 66 are opposed to the nozzle holes 65A of the nozzle plate 65, the opening area of the air supply port 77 is constant. Accordingly, the air supply rate is constant. However, when the position change plate 66 is further moved in the X direction, the opening area of the nozzle holes 65A is changed according to the movement amount of the position change plate 66 to be small, and thus the air supply rate becomes further higher. As described above, by changing the air supply rate of the hot wind in the drying space 67 (continuous sheet 12), it is possible to put intonation, and thus it is possible to solve the stagnation of the hot wind.

Next, an operation of the printer 11 will be described.

In the printer 11 with the configuration described above, the continuous sheet 12 is intermittently sent along the transport direction from the roll body 120 supported by the winding shaft 18 by the supply transport system, the printing operation based on the printing head 36 is sequentially performed on a predetermined printing area of the continuous sheet 12 transported on the platen 28, and a predetermined liquid is applied onto the surface 12a of the continuous sheet 12 (printing step). The continuous sheet 12 to which the application material is applied is intermittently transmitted in the drying space 67 of the drying device 10 by the supply transport system (transport step), and the drying process is sequentially performed in each printing area (drying step).

More specifically, when the printer 11 is driven to start the printing process, the hot wind is supplied from the supply device 8 to the supply space 64 in the drying device 10 as described in FIG. 4 without depending on whether or not the continuous sheet 12 is disposed in the drying space 67, the hot wind flows toward the −X side. The hot wind flowing in the supply space 64 is supplied to the continuous sheet 12 disposed in the drying space 67 through the air supply port 77 configured by the through-holes 66A of the position change plate 66 and the nozzle holes 65A of the nozzle plate 65.

When the continuous sheet 12 to which the ink is applied on the surface 12a thereof in the drying space 67 of the drying device 10, the controller 44 drives the driving motor 69 of the air supply position changing mechanism 70 to operate the ball screw unit 68 and slides the position change plate 66 to move forward and backward within a predetermined drying time along the X direction. The drying time is set according to the kind of the printing medium and the printing time. For example, when the printing time on the continuous sheet 12 is 10 seconds, the movement velocity of the position change plate 66 is 5 m/s. The position change plate 66 may be configured to be slid along the Y direction.

When the position change plate 66 is moved, the positions of the through-holes 66A opposed to the nozzle holes 65A of the nozzle plate 65 are changed, and the position of the air supply port 77 for supplying the hot wind to the drying space 67 is changed. That is, the position of blowing the hot wind to the continuous sheet 12 is changed.

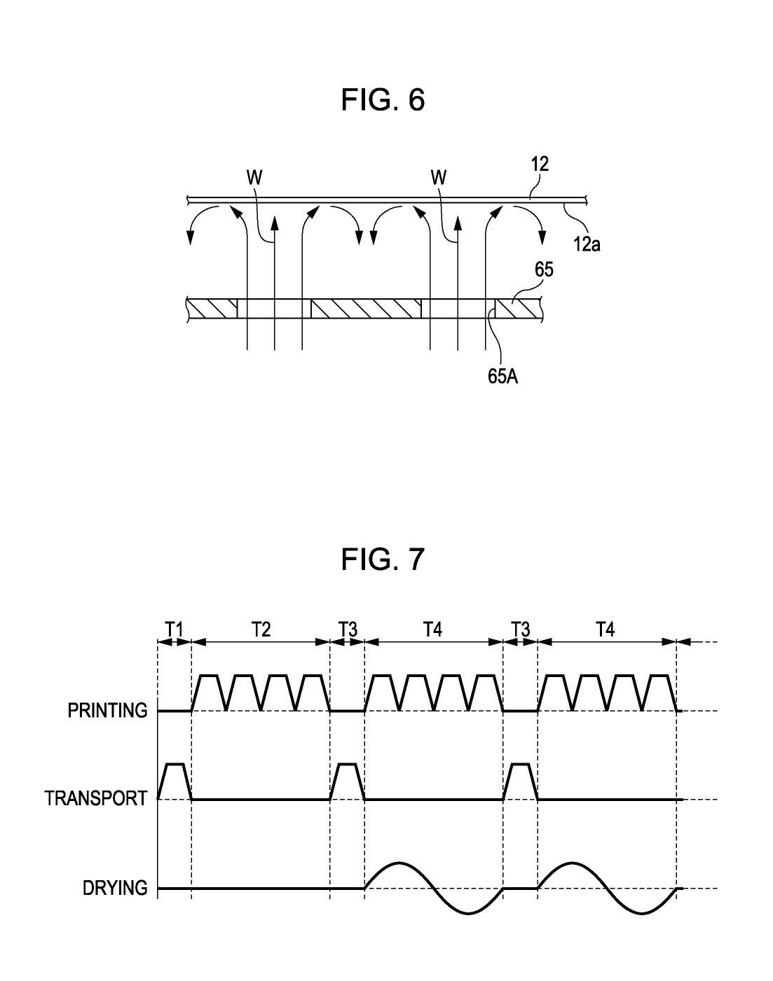

FIG. 6 is a diagram illustrating the flow state of the hot wind supplied to the continuous sheet.

As shown in FIG. 6, a distance between the plurality of nozzle holes 65A and the surface 12a of the continuous sheet 12 is constant. For this reason, when the hot wind is ejected to the stationary continuous sheet 12 to dry the ink by discharging the hot wind into the drying space 67 through only the plurality of nozzle holes 65A, a part, to which the supplied hot wind W is directly ejected and applied, of the continuous sheet 12 is uniformly dried. However, stagnation may occur, for example, in an area C opposed to a gap part between the nozzle holes 65A adjacent to each other in the Y direction, and thus a vapor pressure may elevate.

According to the drying device 10 of the embodiment described above, the position of the air supply port 77 about the drying space 67 is changed by moving the position change plate 66 with respect to the nozzle plate 65, and thus it is possible to blow out the hot wind fluctuating with respect to the stationary continuous sheet 12. For this reason, it is possible to blow out the hot wind to the whole of the surface 12a of the continuous sheet 12 without allowing the hot wind between the nozzle plate 65 and the continuous sheet 12 to stagnate. As described above, by blowing out the hot wind to the whole of the continuous sheet 12 without exception, it is possible to dry the ink in uniform drying conditions.

The hot wind used to dry the continuous sheet 12 in the drying space 67 is discharged through the air discharge port 71 by the operation of the discharge device.

FIG. 7 is a diagram illustrating a timing chart in the printing process and the drying process of the printer 11.

As shown in FIG. 7, first, the continuous sheet 12 is initially transported to be placed on the platen 28 (initial transport period T1), and the printing operation (four passes) of moving forward and backward four times in the Y direction is performed while moving the carriage 35a of a lateral manner in the X direction in a predetermined printing area of the continuous sheet 12 (printing period T2). When the printing operation is completed, the continuous sheet 12 is intermittently transported by the supply transport system and the discharge transport system described above, and is transported into the drying device (transport period T3). The printing-completed area of the continuous sheet 12 transported in the transport period T3 is transported into the drying device 10, and the subsequent printing area is placed on the platen 28.

The printing process is performed on the subsequent printing area of the continuous sheet 12. Meanwhile, in the drying device 10, in the printing-completed area transported to the drying space 67, the position change plate 66 of the air supply position changing mechanism 70 is moved forward and backward once in the X direction to dry the ink attached to the area (printing and drying period T4). After both of the printing process and the drying process are completed, the continuous sheet 12 is transported. As described above, while the drying process performed on the area printed in advance in the continuous sheet 12, the printing process is performed on the subsequent printing area.

In the embodiment, the position change plate 66 is moved forward and backward once at the time of the drying process, but is not limited thereto, and may be moved forward and backward many times. The number of movement cycles of the position change plate 66 in the drying process is set according to characteristics of an object material, and it is possible to secure the same quality at each cycle in each printing area of the intermittently transported continuous sheet 12 by moving at the same number of cycles for each drying process.

As described above, in the embodiment, by moving the position change plate 66 in the X direction with respect to the nozzle plate 65 to change the overlapping position of the through holes 66A about the nozzle holes 65A, the position of the air supply port 77 for supplying the hot wind to the drying space 67 is changed in the X direction. Accordingly, since the wind blow position of the hot wind blown out to the continuous sheet 12 is changed, the continuous sheet 12 is uniformly dried without causing the hot wind to stagnate and it is possible to prevent the drying blur from occurring. In a case of intermittently transporting the continuous sheet 12 and performing the drying process on the stationary continuous sheet 12, when the hot wind is blown from a regular wind blow position, the stagnancy easily occurs and the drying blur easily occurs. However, as described in the embodiment, by changing the position of blowing out the hot wind to the continuous sheet 12, the stagnancy of the hot wind is prevented from occurring, and it is possible to complete the drying of the continuous sheet 12 within a predetermined drying time. Accordingly, in the embodiment, the drying process is performed on the intermittently transported stationary continuous sheet 12, and thus it is possible to effectively dry the continuous sheet 12 even in a situation in which the stagnancy easily occurs.

In the embodiment, by the configuration of moving the position change plate 66 within the pitch range of the nozzle holes 65A of the nozzle plate 65, it is possible to effectively prevent the drying blur without causing the large size of the apparatus.

One cycle of the printing process is set according to the side of taking a time between the printing process and the drying process, and the process does not transfer to the next frame until any process is completely ended. In the embodiment, the drying time is set according to the printing time, and thus the times taken in the processes are the same. However, for example, even when the drying time is shorter than the printing time, the continuous sheet 12 including the printing area of the drying target may exist in the drying device 10 in a drying-completed state.

### Modification Example

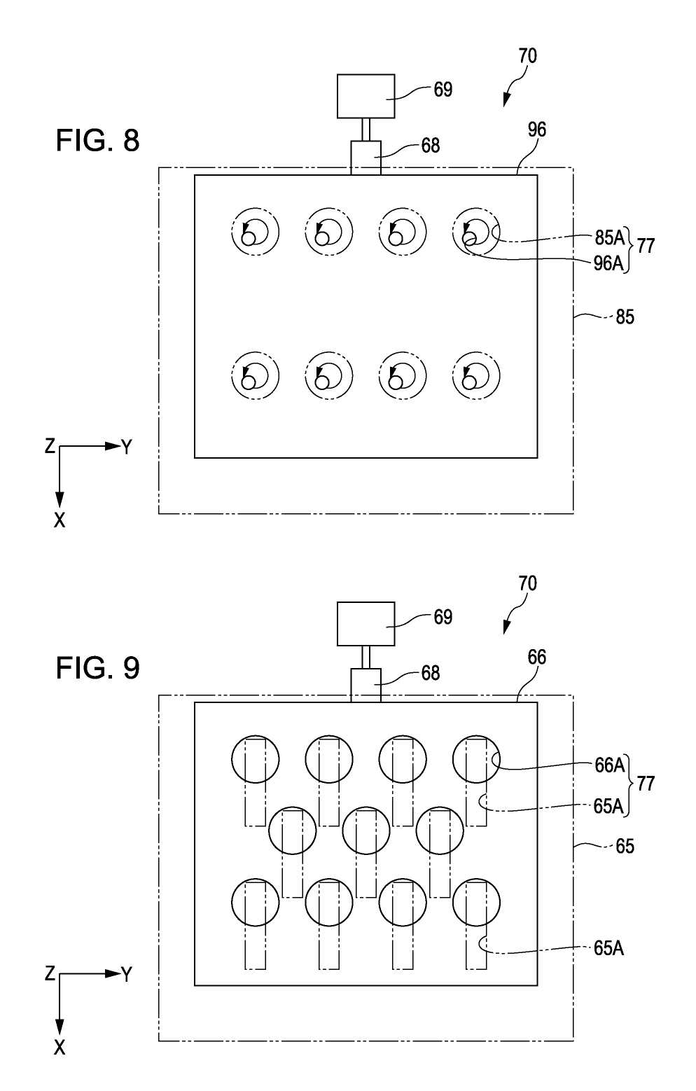

FIG. 8 is a schematic diagram illustrating a modification example of the air supply position changing mechanism.

The air supply position changing mechanism shown in FIG. 8 includes a nozzle plate 85 having a plurality of nozzle holes 85A having a circular shape in the plan view, and a position change plate 96 disposed on the rear face side of the nozzle plate 85 and having a plurality of through-holes 96A with a diameter smaller than that of the nozzle holes 85A. The position change plate 96 is configured to be movable to draw a circle on the XY plane by an eccentric cam mechanism (not shown). In this case, by performing a movement control of the position change plate 96 to move the through-holes 96A opposed to the nozzle holes 85A in the opening area of the nozzle holes 85A, the position of the air supply port 77 configured by the nozzle holes 85A and the through-holes 96A is changed. As described above, the movement direction of the position change plate may be configured to be movable in a secondary direction as well as a primary direction.

The shapes of the nozzle holes 85A and the through-holes 96A in the plan view are not limited to the circular shape, and the shapes may be different from each other.

The preferred embodiments according to the invention have been described with reference to the accompanying drawings, but it is obvious that the invention is not limited to the related examples. Various shapes and combinations of the constituent members represented in the examples described above are an example, and variously modified on the basis of design requirement or the like in the scope which does not deviate from the main concept of the invention.

For example, the pitches of the nozzle holes 65A and the through-holes 66A in the X direction and the Y direction are not limited to the pitches described above. In the embodiment, the nozzle holes 65A are disposed in the lattice shape, but are not limited thereto. As shown in FIG. 9, the disposition of the rows of the nozzle holes 65A arranged with a gap in the Y direction may be zig-zag disposition in which the row adjacent to each other in the X direction deviate by a half pitch. In this case, the through-holes 66A are disposed similarly to the zig-zag arrangement of the nozzle holes 65A.

The pitches of the through-holes 66A in the X direction and the Y direction are not also limited to the pitches described above.

In the embodiment, the configuration of intermittently transporting the continuous sheet 12 has been exemplified, but the invention is not limited thereto. The continuous sheet 12 may be continuously transported to perform the printing process and the drying process. When the drying is performed while continuously transporting the continuous sheet 12, it is possible to blow out the hot wind from the supply device 8 to the continuous sheet 12 through the air supply port 77 by continuously moving the position change plate 66 forward and backward at a predetermined velocity according to the transport velocity of the continuous sheet 12.

A base material to which the application material is applied is not limited to the continuous material, and may be applied to a configuration of performing the printing process and the drying process in every time transport. Alternatively, it may be a film. When a film in which the application material is not easily absorbed therein is used, the whole moisture of the application material has to be evaporated, and thus more time is taken in drying when compared with the sheet. For this reason, by setting the movement velocity of the position change plate 66 to be lower than that of the continuous sheet 12, it is possible to uniformly dry the ink of the whole film.

A plurality of the drying devices 10 may be provided in the transport direction of the continuous sheet 12.

In the embodiment, the drying device 10 according to the invention is provided in the printer 11, but is not limited thereto, and may be widely applied to a drying target to which an application material is applied onto a base material.

In the embodiment described above, the printing apparatus ejecting the liquid such as the ink been exemplified as the printing device, but the invention may be applied to a printing apparatus that ejects and feeds a liquid other than the ink. The liquid which can be applied by the printing apparatus includes a liquid body and a gel-type flow body in which functional material particles are dispersed or dissolved.

In the embodiment described above, as the liquid ejected from the printing apparatus, a liquid corresponding to a specific usage may be applied as well as the ink. An ejection head capable of ejecting the liquid corresponding to the specific usage is provided, the liquid corresponding to the specific usage is ejected from the ejection head, the liquid is attached to a predetermined object, and thus it is possible to produce a predetermined device. For example, the printing apparatus may be applied to a printing apparatus that ejects a liquid (liquid body) in which a material such as an electrode material and a color material used in production of a liquid crystal display, an EL (electroluminescent) display, a face-emitting display (FED), and the like is dispersed (dissolved) in a predetermined dispersion medium.

The printing apparatus may be a printing apparatus ejecting a bio-organic material used to produce a bio chip and a printing apparatus ejecting a liquid that is used as a precise pipette and is a sample.

The printing apparatus may be a printing apparatus ejecting a lubricant to a precision machine such as a clock and a camera by a pinpoint, a printing apparatus ejecting a transparent resin liquid such as ultraviolet curing resin onto a substrate to form a small hemisphere lens (optical lens) used in an optical communication element and the like, a printing apparatus ejecting an etching liquid of acid or alkali to etch a substrate or the like, and a flow body ejecting apparatus ejecting a gel. The invention may be applied to any one kind of apparatuses.

What is claimed is:

1. A printing apparatus comprising:
a printing unit that applies a liquid to a printing medium to perform printing;
a support member that supports the printing medium;
a drying device that dries the liquid applied onto the printing medium in a drying space; and
a control device that is connected to the drying device,
wherein the drying device includes an air supply port for supplying a drying gas to the drying space, and an air supply position changing mechanism that changes a position of the air supply port for the drying space with respect to the printing medium.

2. The printing apparatus according to claim 1, wherein the air supply port is configured by a plurality of first supply holes which are open to the drying space and a plurality of second supply holes disposed at positions overlapping the first supply holes in a plan view, and
wherein the air supply position changing mechanism moves a second plane on which the plurality of second supply holes are disposed in parallel with respect to a first plane on which the plurality of first supply holes are disposed, to change the position of the air supply port.

3. The printing apparatus according to claim 2, wherein the air supply position changing mechanism moves the second plane in parallel with respect to the first plane such that an opening area of the air supply port is constant.

4. A control method of a printing apparatus including a printing unit that applies a liquid to a printing medium to perform printing, a support member that supports the printing medium, a drying device that dries the liquid applied onto the printing medium in a drying space, and a control device that is connected to the drying device, in which the drying device includes an air supply port for supplying a drying gas to the drying space, and an air supply position changing mechanism that changes a position of the air supply port for the drying space with respect to the printing medium, the method comprising:
printing an image by applying the liquid to the printing medium;
transporting the liquid applied onto the printing medium to the drying space; and
drying the liquid on the printing medium disposed in the drying space,
wherein in the drying, the position of the air supply port for supplying the drying gas to the drying space is changed with respect to the printing medium.

5. The control method of the printing apparatus according to claim 4, wherein in the drying, the position of the air supply port is changed every time at the same cycle within a predetermined drying time.

6. The control method of the printing apparatus according to claim 4, wherein the drying to the printing medium positioned at the front of the transport direction and the printing on the printing medium positioned relatively at the rear of the transport direction are simultaneously performed.

7. The control method of the printing apparatus according to claim 5, wherein the drying time may be the same time as the printing time in the printing.
